(19) United States
(12) Patent Application Publication
(10) Pub. No.: US 2022/0247024 A1
(43) Pub. Date: Aug. 4, 2022

(54) BATTERY MODULE SYSTEMS WITH ISOLATED SUB-MODULES

(71) Applicant: Electric Power Systems, Inc., North Logan, UT (US)

(72) Inventors: James Banwell, Montclair, CA (US); Randy Dunn, Orange, CA (US)

(73) Assignee: Electric Power Systems, Inc., North Logan, UT (US)

(21) Appl. No.: 17/665,333

(22) Filed: Feb. 4, 2022

Related U.S. Application Data
(60) Provisional application No. 63/145,680, filed on Feb. 4, 2021.

(51) Int. Cl. H01M 50/213; H01M 10/613; H01M 50/30; H01M 50/502; H01M 50/249

(52) U.S. Cl. CPC H01M 50/213; H01M 10/613; H01M 2220/20; H01M 50/502; H01M 50/249; H01M 50/30

(57) ABSTRACT

A battery module may comprise: a common mounting structure including a cooling system and a venting system; and a first plurality of battery cell sub-modules, the first plurality of battery cell sub-modules disposed on a first side of the common mounting structure and coupled to the common mounting structure.

### CROSS-REFERENCE TO RELATED APPLICATIONS

This application is a non-provisional of, and claims priority to, and the benefit of U.S. Provisional Application No. 63/145,680, entitled “BATTERY MODULE SYSTEMS WITH ISOLATED SUB-MODULES,” filed on Feb. 4, 2021, which is hereby incorporated by reference in its entirety.

### FIELD OF INVENTION

The present disclosure generally relates to apparatus, systems and methods for providing battery systems with thermally isolated sub-modules.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low cost rechargeable energy for portable electronics.

Custom battery solutions may be expensive for a respective customer. Custom battery solutions may include longer lead times due to the customization desired by the customer. Custom battery solutions may be engineering intensive to meet desired characteristics by a customer.

### SUMMARY OF THE INVENTION

A battery module containing various thermally isolated modules is disclosed herein. In various embodiments, the battery module may provide a method of minimizing and containing thermal runaway events. In various embodiments, each sub-module in the plurality of sub-modules may be considered a battery in its own regard. Each sub-module in the plurality of sub-modules may be electrically coupled to a remainder of the plurality of sub-modules to form the battery module. In various embodiments, the battery module is configured to prevent propagation of a thermal runaway event in a first sub-module to any of the remainder of the plurality of sub-modules.

In various embodiments, the battery module includes a multi-functional common mounting structure. The common mounting structure may be configured to (1) have the plurality of sub-modules mounted thereto; (2) provide venting for ejecta of a sub-module in the event of thermal runaway; (3) provide an electrical connection between sub-modules; (4) provide an electrical connection to electrical ports; and/or (5) provide a common cooling source for the plurality of sub-modules.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates an exploded view and a perspective view of a battery module, in accordance with various embodiments;

FIG. 2 illustrates an exploded view and a perspective view of a battery module, in accordance with various embodiments; and

FIG. 3 illustrates a schematic view of an electrically powered aircraft having a battery module, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

Typical battery modules may allow a cell entering thermal runaway to cascade to the rest of a typical battery module. For example, large battery modules with a significant number of cells may result in a fire due to propagation of a cell entering thermal runaway to other cells without thermal runaway mitigation for typical battery modules. Disclosed herein is a battery module having a plurality of thermally isolated sub-modules. In this regard, if a cell in a sub-module enters thermal runaway, the thermal runaway event may only cascade to other cells within the sub-module. Although described herein with respect to cylindrical cells, the present disclosure is not limited in this regard. For example, one skilled in the art may recognize various applications for prismatic cells, pouch cells, or the like.

In various embodiments, each sub-module in the plurality of sub-modules is configured to contain fire, smoke, and/or debris if a thermal runaway event occurs. Each sub-module in the plurality of sub-modules may be insulated via a high temperature, high thermal resistance insulating material, such as alumina oxide ceramic fiber materials, calcium aluminum silicate ceramic fiber materials, alkaline earth silicate ceramic fiber materials, or the like. In various embodiments, each sub-module in the plurality of sub-modules may include an enclosure, which may be made of sheet metal (e.g., stainless steel, titanium, aluminum, nickel, etc.), a thermoplastic, or any other suitable material.

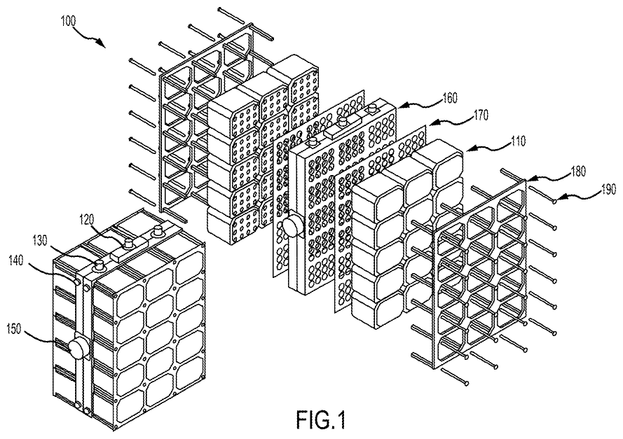

Referring now to FIGS. 1A and 1B, an exploded view (FIG. 1A) and an assembled view (FIG. 1B) of a battery module 100 having a plurality of battery cell sub-modules 110 is illustrated, in accordance with various embodiments. each battery cell sub-module in the plurality of battery cell sub-modules 110 is at least partially thermally isolated from a remainder of the plurality of battery cell sub-modules 110. “Thermally isolated,” as defined herein refers to preventing propagation of a thermal runaway event from a battery cell sub-module in the plurality of battery cell sub-modules 110 to an adjacent battery cell sub-module in the plurality of battery cell sub-modules 110. In this regard, a sub-module being thermally isolated from adjacent sub-modules refers to substantially no mass or heat energy entering the sub-module in response to an adjacent sub-module entering thermal runaway. “Substantially” no mass or heat energy refers to a sub-module maintain a temperature plus or minus 5% throughout a thermal runaway event of a cell in an adjacent sub-module.

In this regard, the battery module 100 is configured to prevent cells in a battery cell sub-module from entering thermal runaway in response to a cell in an adjacent battery cell sub-module entering thermal runaway. Thermal runaway may occur for a given cell in response to the cell exceeding a thermal runaway ignition temperature (e.g., between 60° C. and 100° C. for a lithium-ion battery cell sub-module), in accordance with various embodiments.

In various embodiments, the battery module 100 may be configured for use on an aircraft. Although discussed further herein as being configured for an aircraft, the present disclosure is not limited in this regard. For example, the battery module 100 could be used in other electric vehicles, such as electric cars, electric trucks, electric boats, or the like.

In various embodiments, the battery module 100 comprises the plurality of battery cell sub-modules 110, a battery monitoring electronics module 120, power connectors 130, a cooling system 140, a venting system 150, and a common mounting structure 160. In various embodiments, the battery monitoring electronics module 120 is electrically coupled to the plurality of battery cell sub-modules 110 and a plurality of cells disposed therein. Similarly, the power connectors 130 are electrically coupled to the plurality of battery cell sub-modules and the plurality of cells disposed therein. In various embodiments, the power connectors 130 include a positive terminal and a negative terminal. The power connectors 130 are external connectors configured to electrically connect the battery module 100 to any electrically powered component (e.g., ground power, emergency power, improving direct current bus stability, fault clearing, electric motors, etc.).

In various embodiments, the cooling system 140 may comprise a liquid coolant system. Although illustrated as including a liquid coolant system, the cooling system 140 is not limited in this regard. For example, an air coolant system may be utilized, in accordance with various embodiments. The cooling system 140 may include an inlet port and an outlet port, and a cooling channel disposed through the common mounting structure 160. In this regard, coolant may flow into the inlet port, through the cooling channel and out the outlet port. Thus, the cooling system 140 may conductively cool the plurality of battery cell-sub modules through the common mounting structure 160. In various embodiments, the common mounting structure 160 may act as a cooling end plate for a first plurality of battery cell sub-modules in the battery cell sub-modules 110 disposed on a first side of the common mounting structure 160 and a cooling end plate for a second plurality of battery cell sub-modules in the battery cell sub-modules 110 disposed on a second side of the common mounting structure 160. In this regard, the first plurality of battery cell sub-modules may mirror the second plurality of battery cell sub-modules about the common mounting structure 160, in accordance with various embodiments.

Although illustrated as including the first plurality of battery cell sub-modules and the second plurality of battery cell submodules sandwiching the common mounting structure 160, the present disclosure is not limited in this regard. For example, a plurality of battery cell sub-modules may extend only from a single side, in accordance with various embodiments. However, by having the first plurality of battery cell sub-modules and the second plurality of battery cell sub-modules sandwiching the common mounting structure, a more compact battery module with greater weight savings may be achieved relative to only having the battery modules on a single side of the common mounting structure 160.

In various embodiments, the venting system 150 includes a venting port configured to exhaust ejecta from the battery module 100 in a thermal runaway event of a cell in a battery cell sub-module in the plurality of battery cell sub-modules 110. In this regard, the common mounting structure 160 may include a plurality of apertures, each aperture configured to align with a respective cell in a respective battery cell sub-module in the plurality of battery cell sub-modules 110. Similarly, an electrical insulator gasket 170 may include a plurality of apertures, each aperture configured to align with a respective cell in a respective battery cell sub-module in the plurality of battery cell sub-modules 110. The electrical insulator gasket 170 may be disposed between the common mounting structure 160 and the plurality of battery cell sub-modules 110 and configured to electrically insulate the cells within each battery cell sub-module from the common mounting structure 160.

In various embodiments, the battery module 100 further comprises at least one frame 180. In various embodiments, the frame 180 is configured to secure the plurality of battery cell sub-modules 110 to the common mounting structure by any method known in the art, such as via fasteners 190, or the like.

In various embodiments, the common mounting structure 160 is a multi-purpose mounting structure. For example, the common mounting structure 160 provides an anchoring point and/or a mounting point for all of the battery cell sub-modules in the plurality of battery cell sub-modules 110, the common mounting structure 160 provides at least a portion of the venting system 150, and/or at least a portion of the cooling system 140.

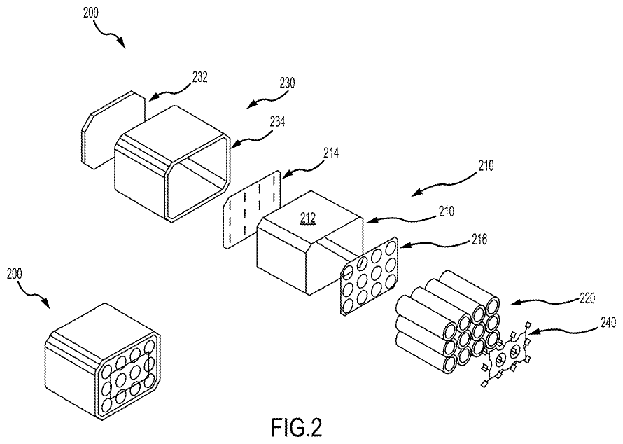

Referring now to FIG. 2, an exploded view of a battery cell sub-module 200, in accordance with various embodiments, is illustrated. In various embodiments, each battery cell sub-module in the plurality of battery cell sub-modules 110 from FIG. 1 is in accordance with the battery cell sub-module 200 from FIG. 2. In this regard, the battery module 100 may be modular and repeatable, which may facilitate cost savings in manufacturing due to economies of scale or the like, in accordance with various embodiments. In various embodiments, the battery cell sub-module 200 includes a housing 210, a plurality of cells 220, an insulation system 230, and a conductor strap 240.

In various embodiments, the housing 210 may be configured to structurally support the plurality of cells 220 and/or thermally insulate the plurality of cells 220 from adjacent battery cell sub-modules (e.g., as illustrated in the battery module 100 from FIG. 1). The housing 210 may be made of any material known in the art, such as stainless steel, nickel, aluminum, a polymeric material (e.g., a thermoset plastic or the like), etc. In various embodiments, the housing 210 is configured to structurally support the plurality of cells 220 and be coupled to the common mounting structure 160 from FIG. 1. In various embodiments, the housing 210 comprises a sidewall 212, a back end plate 214, and a front end plate 216. Although illustrated as being separate pieces, the sidewall 212 and the back end plate 214 may be monolithic, in accordance with various embodiments. In various embodiments, the front end plate 216 may be disposed proximal the common mounting structure 160 from FIG. 1 when the battery module 100 from FIG. 1 is assembled. In this regard, the front end plate 216 may further comprise a plurality of apertures, each aperture configured to align with a respective cell in the plurality of cells 220. Thus, in response to a thermal runaway event, ejecta from a cell may be ejected through the respective aperture and into a venting manifold of venting system 150 from FIG. 1 and out a vent port. In various embodiments, the plurality of cells 220 may be disposed between the back end plate 214 and the front end plate 216. In various embodiments, the plurality of apertures in the front end plate 216 may be closed via a thermally sensitive valve (e.g., a material configured to melt at a threshold temperature). The thermally sensitive valve may be made of eutectic or fusible alloys with low melting points, including alloys of lead, bismuth, and tin, and commonly known by names like Wood's Metal, Rose Metal, and Lipowitz's Alloy. Such metals are used in fire sprinkler valves, preventing pressurized water from exiting a pipe until triggered by heat, at which time the alloy softens sufficiently to release ejecta in a thermal runaway event or the like. In this regard, the thermally sensitive valve may also prevent propagation from one sub-module to another sub-module in the battery module 100 from FIG. 1.

In various embodiments, in an assembled state, the plurality of cells 220 are disposed within the housing 210 and surrounded at least partially by the insulation system 230. Although illustrated as including a twelve cell battery cell sub-module 200, the present disclosure is not limited in this regard. In various embodiments, the lower the number of cells, the greater a margin of safety may be achieved for a battery module 100 from FIG. 1. Yet, the lower the number of cells per battery cell sub-module 200, the greater the weight for a battery module 100 from FIG. 1. Thus, one skilled in the art may appreciate a trade-off between weight and margin of safety for a respective battery module 100, in accordance with various embodiments.

In various embodiments, the insulation system 230 may include an insulating base plate 232 and an insulating side plate 234. In this regard, the insulation system 230 may be configured to direct any heat from a thermal runaway event, or the like, away from the insulating base plate 232 in a direction normal to the insulating base plate 232 to a common vent (e.g., vent port of venting system 150 from FIG. 1) as described previously herein. In this regard, any heat or ejecta may be directed based on the configuration of the insulation system 230, in accordance with various embodiments.

In various embodiments, the plurality of cells 220 may be electrically coupled together by any method known in the art. For example, the plurality of cells 220 may be electrically coupled together in series or parallel via a conductor strap 240. In various embodiments, conductor strap 240 may be joined to each cell in the plurality of cells 220 by welding, soldering, brazing, or the like. In various embodiments, joining the conductor strap 240 to the plurality of cells 220 couples the cells electrically and physically. In various embodiments, each sub-module 200 may be electrically coupled to an adjacent sub module 200 in parallel or in series. The present disclosure is not limited in this regard.

In various embodiments, the battery module 100 from FIG. 1 may facilitate weight and cost saving for aircraft batteries, while maintaining safety by preventing propagation of a thermal runaway event. In various embodiments, by having the common mounting structure 160 from FIG. 1 as a multi-functional mounting port, additional weight savings may be achieved.

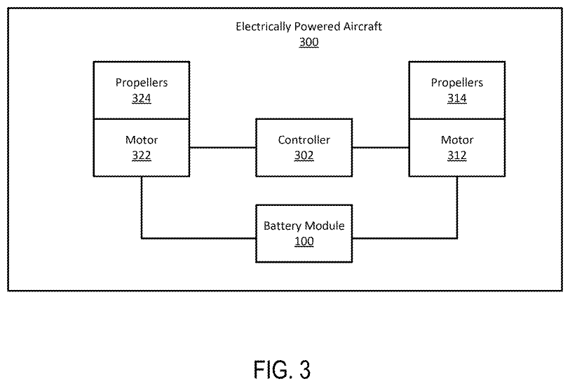

Referring now to FIG. 3, a schematic view of an electrically powered aircraft with the battery module 100 from FIG. 1 is illustrated, in accordance with various embodiments. In various embodiments, the electrically powered aircraft 300 comprises a controller 302, motors 312, 322, and propellers 314, 324. Each motor 312, 322 is operably coupled to a respective propeller 314, 324. Each motor 312, 322 is electrically coupled to the battery module 100. In this regard, the battery module 100 is configured to power the motors 312, 322 to drive the respective propellers 314, 324 and power the electrically powered aircraft 300, in accordance with various embodiments. In various embodiments, the controller 302 is configured to command the motors 312, 322 to pull power from the battery module 100 during operation of the electrically powered aircraft 300.

In various embodiments, as described previously herein, the common mounting structure 160 of the battery module 100 facilitates cost and weight savings by being able to couple the battery cell sub-modules 200 on opposite sides. In various embodiments, by having each battery cell sub-module 200 thermally isolated from a remainder of battery cell sub-modules in the plurality of battery cell sub-modules 110, a cell entering thermal runaway will not propagate to adjacent battery cell sub-modules 110, allowing the battery module 100 to maintain sufficient power to motors 312, 322 to maintain flight and land the electrically powered aircraft 300. In this regard, the battery module 100 may provide enhanced safety benefits relative to typical electrically powered aircrafts, in accordance with various embodiments.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. A battery module, comprising:
a common mounting structure including a cooling system and a venting system; and
a first plurality of battery cell sub-modules, the first plurality of battery cell sub-modules disposed on a first side of the common mounting structure and coupled to the common mounting structure.

2. The battery module of claim 1, further comprising a second plurality of battery cell sub-modules disposed on a second side of the common mounting structure and coupled to the common mounting structure.

3. The battery module of claim 2, wherein each battery cell sub-module in the first plurality of battery cell sub-modules and the second plurality of battery cell sub-modules includes a housing and a plurality of cells.

4. The battery module of claim 3, wherein the plurality of cells are disposed in the housing.

5. The battery module of claim 4, wherein the plurality of cells are electrically coupled together.

6. The battery module of claim 2, further comprising power connectors, wherein the power connectors are electrically coupled to the first plurality of battery cell sub-modules and the second plurality of battery cell sub-modules.

7. The battery module of claim 2, wherein each battery cell sub-module is thermally isolated from a remainder of battery cell sub-modules in the first plurality of battery cell sub-modules and the second plurality of battery cell sub-modules.

8. The battery module of claim 7, wherein the battery module is configured to prevent propagation of a thermal runaway event from the respective battery cell sub-module to any of the remainder of battery cell sub-modules.

9. A battery module, comprising:
a first battery cell sub-module coupled to a common mounting structure, the first battery cell sub-module comprising a first plurality of cells disposed therein and electrically coupled together; and
a second battery cell sub-module coupled to the common mounting structure, the second battery cell sub-module comprising a second plurality of cells disposed therein and electrically coupled together, the second plurality of cells electrically coupled to the first plurality of cells, the second battery cell sub-module disposed adjacent to the first battery cell sub-module, the second plurality of cells thermally isolated from the first plurality of cells within the second battery cell sub-module.

10. The battery module of claim 9, wherein an environment within the second battery cell sub-module maintains a first temperature plus or minus five percent throughout a thermal runaway event of a cell in the first plurality of cells.

11. The battery module of claim 9, further comprising a third battery cell sub-module coupled to the common mounting structure, the third battery cell sub-module disposed adjacent to the second battery cell sub-module.

12. The battery module of claim 11, further comprising a fourth battery cell sub-module coupled to a second side of the common mounting structure, wherein the first battery cell sub-module, the second battery cell sub-module, and the third battery cell sub-module are coupled to a first side of the common mounting structure, and wherein the first side is opposite the second side.

13. The battery module of claim 12, further comprising a fifth battery cell sub-module disposed adjacent to the fourth battery cell sub-module and disposed on the second side of the common mounting structure.

14. The battery module of claim 13, wherein:
the third battery cell sub-module comprises a third plurality of cells electrically coupled together and disposed therein,
the fourth battery cell sub-module comprises a fourth plurality of cells electrically coupled together and disposed therein, and
the fifth battery cell sub-module comprises a fifth plurality of cells electrically coupled together and disposed therein.

15. The battery module of claim 14, wherein the first plurality of cells, the second plurality of cells, the third plurality of cells, the fourth plurality of cells, and the fifth plurality of cells are electrically coupled together.

16. The battery module of claim 15, wherein each battery cell sub-module is thermally isolated from a remainder of battery cell sub-modules.

17. An electrically powered aircraft, comprising:
a motor;
a battery module electrically coupled to the motor, the battery module including a plurality of battery cell sub-modules, wherein:
each battery cell sub-module in the plurality of battery cell sub-modules includes a plurality of cells disposed therein and electrically coupled together,
the plurality of cells of each battery cell sub-module is electrically coupled together to the plurality of cells of each remaining battery cell sub-module in the plurality of battery cell sub-modules, and
the plurality of cells in each battery cell sub-module are thermally isolated from a remaining plurality of cells from a remaining plurality of battery cell sub-modules in the plurality of battery cell sub-modules.

18. The electrically powered aircraft of claim 17, further comprising a propeller operably coupled to the motor.

19. The electrically powered aircraft of claim 17, wherein the plurality of battery cell sub-modules comprises a first set of battery cell sub-modules coupled to a first side of a common mounting structure and a second set of battery cell sub-modules coupled to a second side of the common mounting structure.

20. The electrically powered aircraft of claim 19, further comprising the common mounting structure, wherein the common mounting structure includes a cooling system and a venting system.
